(19) United States
(12) Patent Application Publication
(10) Pub. No.: US 2021/0322259 A1
(43) Pub. Date: Oct. 21, 2021

(54) Massaging Cushion System

(71) Applicant: Colin Mac Intosh, Santa Monica, CA (US)

(72) Inventor: Colin Mac Intosh, Santa Monica, CA (US)

(21) Appl. No.: 16/997,578

(22) Filed: Aug. 19, 2020

Related U.S. Application Data
(63) Continuation-in-part of application No. 16/854,503, filed on Apr. 21, 2020.

(51) Int. Cl. A61H 23/00

(52) U.S. Cl. CPC A61H 23/00; A61H 2201/501; A61H 2201/0134; A61H 2201/0149

(57) ABSTRACT

A massaging cushion system for vibrating a personal cushion includes a personal electronic device that has vibration capabilities such that the personal electronic device is actuatable to vibrate. A cushion is provided and the cushion has a pocket integrated therein. The pocket insertably receives the personal electronic device. The cushion is comprised of a resiliently compressible material thereby facilitating vibration from the personal electronic device to be communicated through the cushion. In this way the cushion enhances comfort for the user by exposing the user to the vibration.

### CROSS-REFERENCE TO RELATED APPLICATION

I hereby claim the benefit under 35 U.S.C., Section 120 of U.S. application Ser. No. 16/854,503 filed on Apr. 21, 2020.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cushion devices and more particularly pertains to a new cushion device for integrating a personal electronic device into a cushion.

### (2) Description of Related Art Including Information Disclosed Under 37 CFR 1.97 and 1.98

The prior art relates to cushion devices including foam rollers that are used to roll over a person's muscles by the person placing the roller under a particular body part to utilize the person's weight as the body port is rolled back and forth over the roller.

### BRIEF SUMMARY OF THE INVENTION

An embodiment of the disclosure meets the needs presented above by generally comprising a personal electronic device that has vibration capabilities such that the personal electronic device is actuatable to vibrate. A cushion is provided and the cushion has a pocket integrated therein. The pocket insertably receives the personal electronic device. The cushion is comprised of a resiliently compressible material thereby facilitating vibration from the personal electronic device to be communicated through the cushion. In this way the cushion enhances comfort for the user by exposing the user to the vibration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a massaging cushion system according to an embodiment of the disclosure.

FIG. 2 is a detail view taken from circle 2 of FIG. 1 of an embodiment of the disclosure.

FIG. 3 is a cross sectional view taken along line 3-3 of FIG. 2 of an embodiment of the disclosure.

FIG. 4 is a perspective view of an embodiment of the disclosure showing a cushion as a tubular roll.

FIG. 5 is a right side view of an embodiment of the disclosure showing a cushion as a tubular roll.

FIG. 6 is a perspective phantom view of an embodiment of the disclosure showing a cushion as a bicycle seat.

FIG. 7 is a perspective phantom view of an embodiment of the disclosure showing a cushion as a wedge.

FIG. 8 is a perspective view of an embodiment of the disclosure showing a pillowcase.

FIG. 9 is a perspective in-use view of an embodiment of the disclosure showing a pillowcase on a mattress.

### DETAILED DESCRIPTION OF THE INVENTION

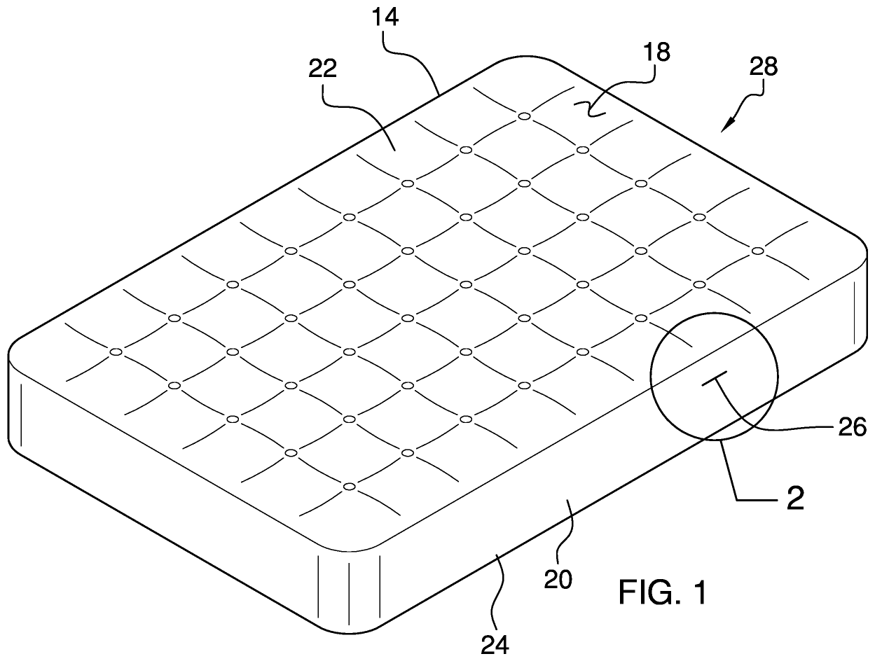

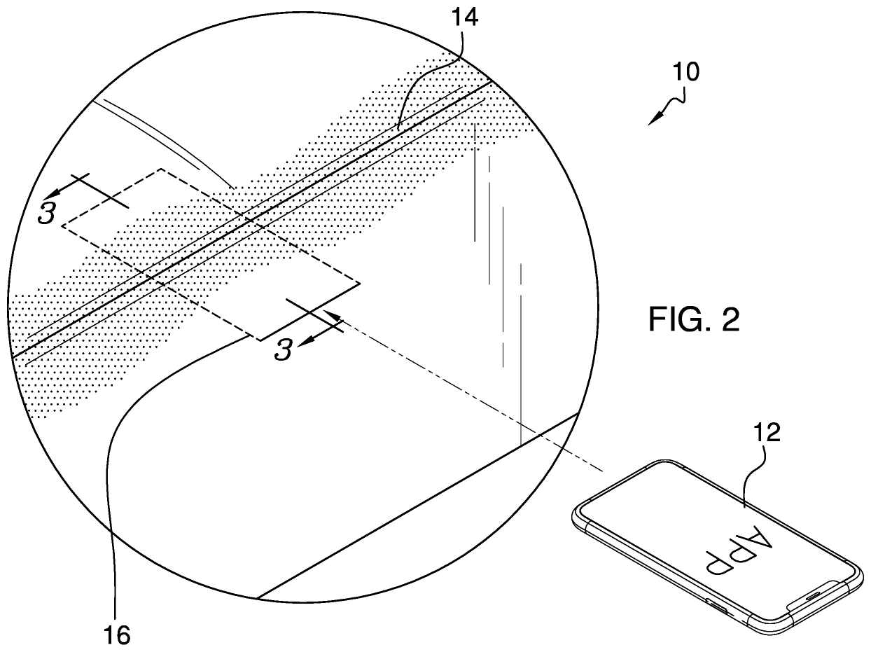

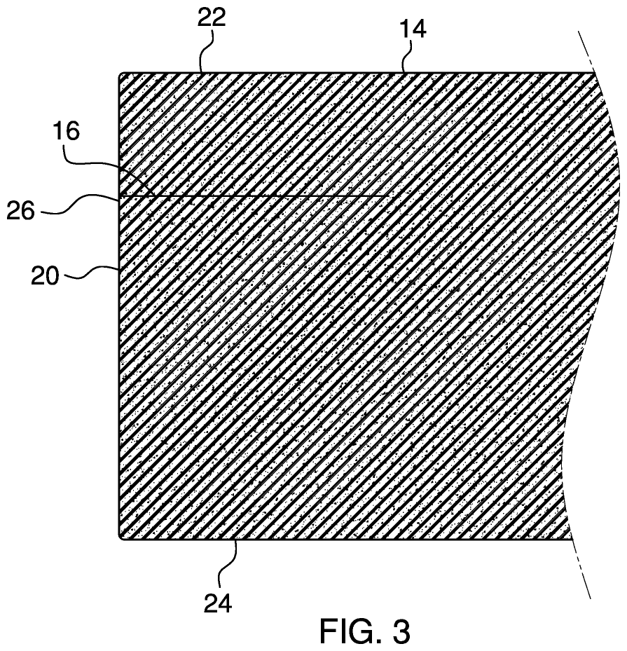

With reference now to the drawings, and in particular to FIGS. 1 through 9 thereof, a new cushion device embodying the principles and concepts of an embodiment of the disclosure and generally designated by the reference numeral 10 will be described.

As best illustrated in FIGS. 1 through 9, the massaging cushion system 10 generally comprises a personal electronic device 12 that has vibration capabilities such that the personal electronic device 12 is actuatable to vibrate. The personal electronic device 12 may comprise a smart phone or the like and the personal electronic device 12 may store operational software, such as a smart phone app, that controls the vibration capabilities of the personal electronic device 12. A cushion 14 is provided and a user can lie on or against the cushion 14. A pocket 16 is integrated into the cushion 14 and the pocket 16 insertably receives the personal electronic device 12. Moreover, the cushion 14 is comprised of a resiliently compressible material thereby facilitating vibration from the personal electronic device 12 to be communicated through the cushion 14. In this way the cushion 14 enhances comfort for the user by exposing the user to the vibration produced by the personal electronic device 12.

The cushion 14 has an outer surface 18 and the outer surface 18 has a first lateral side 20, a top side 22 and a bottom side 24, and the pocket 16 is positioned between the top side 22 and the bottom side 24. The pocket 16 is positioned adjacent to the first lateral side 20. Additionally, the pocket 16 is oriented to extend along a horizontal plane to enhance the ease with which the user can insert the personal electronic device 12 into the pocket 16. The first lateral side 20 has a cut 26 extending into the pocket 16 thereby facilitating the personal electronic device 12 to be inserted into the pocket 16.

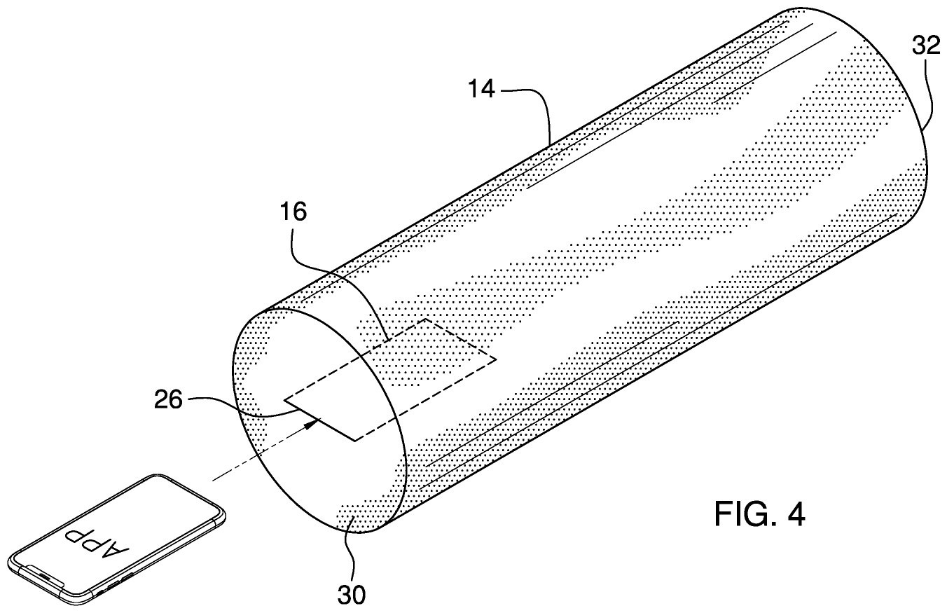

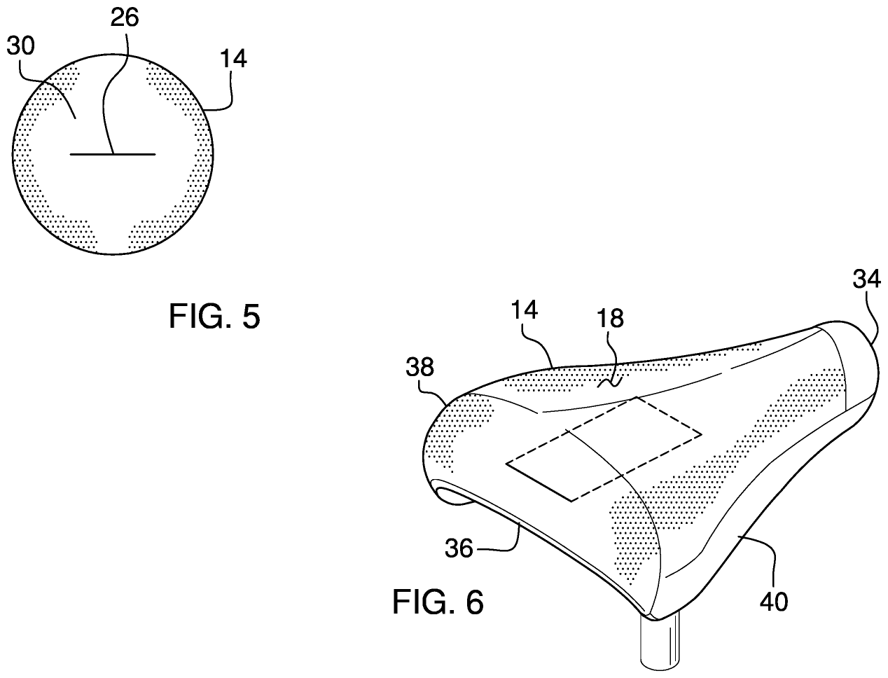

As is most clearly shown in FIGS. 1 through 3, the cushion 14 may comprise a mattress 28 upon which the user can sleep. As is most clearly shown in FIGS. 4 and 5, the cushion 14 may have a first end 30 and a second end 32 having the outer surface 18 extending therebetween. Moreover, the outer surface 18 may be continuously arcuate about an axis extending through the first end 30 and the second end 32. The pocket 16 may be positioned adjacent to the first end 30 and the cut 26 may extend through the first end 30.

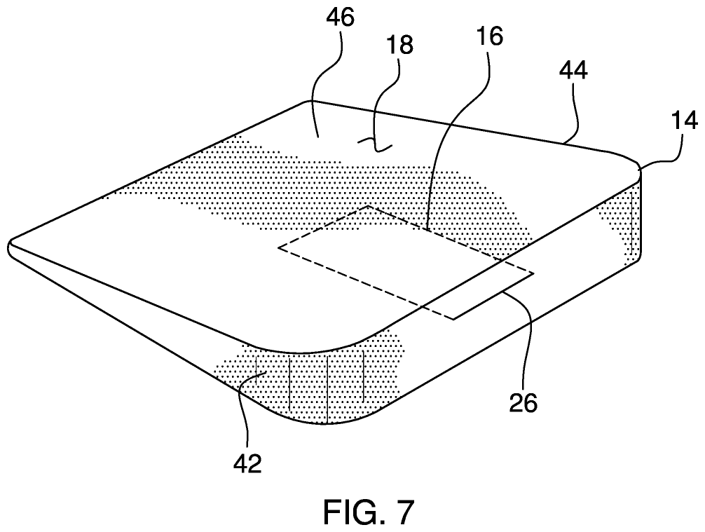

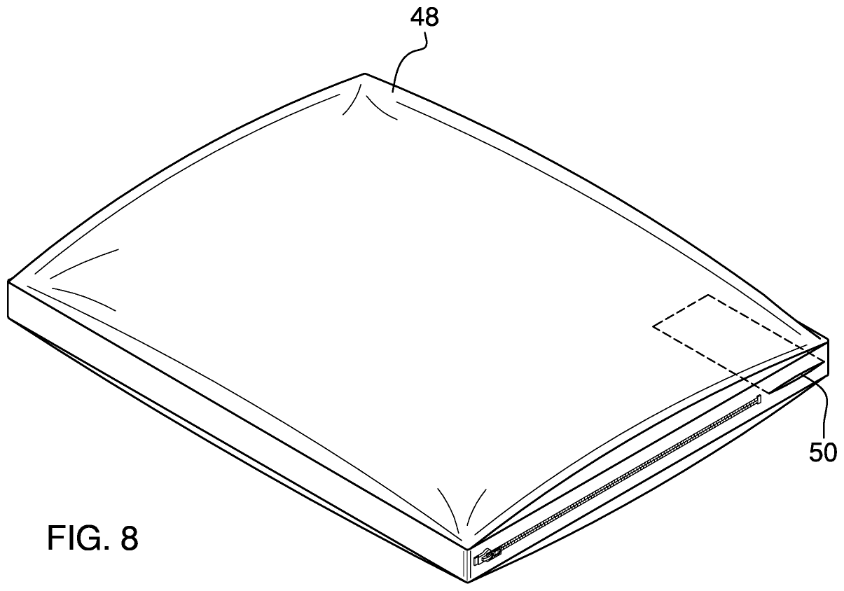

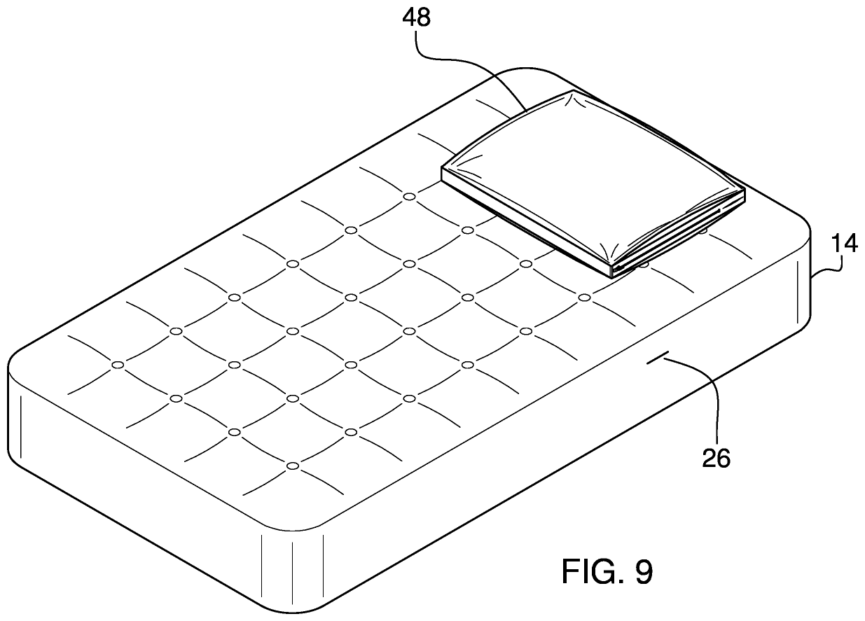

As is most clearly shown in FIG. 6, the outer surface 18 may have a front side 34, a back side 36, a first lateral side 38 and a second lateral side 40. Each of the first lateral side 38 and the second lateral side 40 may angle inwardly between the back side 36 and the front side 34. Moreover, the cushion 14 may be elongated along an axis extending through the front side 34 and the back side 36 such that the cushion 14 defines a bicycle seat. As is most clearly shown in FIG. 7, the outer surface 18 has a first lateral side 42, a second lateral side 44 and a top side 46 that slopes downwardly between the first lateral side 42 and the second lateral side 44 such that the cushion 14 forms a wedge. As is most clearly shown in FIG. 8, a pillowcase 48 may be provided and a slot 50 may be integrated into the pillowcase 48 to receive the personal electronic device 12. In this way the personal electronic device 12 can vibrate a pillow that is stored in the pillowcase 48. As is most clearly shown in FIG. 9, the pillowcase 48 can be laid on the mattress 28 for sleeping.

In use, the personal electronic device 12 is actuated to vibrate and the personal electronic device 12 is inserted into the pocket 16 in the cushion 14. In this way the personal electronic device 12 can vibrate the cushion 14. Thus, the personal electronic device 12 can enhance comfort for the user while the user is employing the cushion 14. The user may employ the cushion 14 as a neck pad for example, as a bicycle seat, for sleeping or for any other purpose.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A massaging cushion system for receiving a personal electronic device which employs a vibration app, said system comprising:
a personal electronic device having vibration capabilities such that said personal electronic device is actuatable to vibrate; and
a cushion being configured to have a user positioned thereagainst, said cushion having a pocket being integrated therein, said pocket insertably receiving said personal electronic device, said cushion being comprised of a resiliently compressible material thereby facilitating vibration from said personal electronic device to be communicated through said cushion wherein said cushion is configured to enhance comfort for the user by exposing the user to the vibration.

2. The system according to claim 1, wherein said cushion has an outer surface, said outer surface having a first lateral side, a top side and a bottom side, said pocket being positioned between said top side and said bottom side, said pocket being positioned adjacent to said first lateral side.

3. The system according to claim 1, wherein said pocket is oriented to extend along a horizontal plane wherein said pocket is configured to enhance the ease with which the user can insert said personal electronic device into said pocket.

4. The system according to claim 2, wherein said first lateral side has a cut extending into said pocket thereby facilitating said personal electronic device to be inserted into said pocket.

5. A massaging cushion system for receiving a personal electronic device which employs a vibration app, said system comprising:
a personal electronic device having vibration capabilities such that said personal electronic device is actuatable to vibrate; and
a cushion being configured to have a user positioned thereagainst, said cushion having a pocket being integrated therein, said pocket insertably receiving said personal electronic device, said cushion being comprised of a resiliently compressible material thereby facilitating vibration from said personal electronic device to be communicated through said cushion wherein said cushion is configured to enhance comfort for the user by exposing the user to the vibration, said cushion having an outer surface, said outer surface having a first lateral side, a top side and a bottom side, said pocket being positioned between said top side and said bottom side, said pocket being positioned adjacent to said first lateral side, said pocket being oriented to extend along a horizontal plane wherein said pocket is configured to enhance the ease with which the user can insert said personal electronic device into said pocket, said first lateral side having a cut extending into said pocket thereby facilitating said personal electronic device to be inserted into said pocket.

6. The system according to claim 5, wherein said cushion comprises a mattress upon which the user can sleep.

7. The system according to claim 5, wherein said cushion has a first end and a second end having said outer surface extending therebetween, said outer surface being continuously arcuate about an axis extending through said first end and said second end, said pocket being positioned adjacent to said first end, said cut extending through said first end.

8. The system according to claim 5, wherein said outer surface has a front side, a back side, a first lateral side and a second lateral side, each of said first lateral side and said second lateral side angling inwardly between said back side and said front side, said cushion being elongated along an axis extending through said front side and said back side wherein said cushion is configured to be mounted as a bicycle seat.

9. The system according to claim 5, wherein said outer surface has a second lateral side, said top side sloping downwardly between said first lateral side and said second lateral side such that said cushion forms a wedge.

10. A massaging cushion assembly for receiving a personal electronic device which employs a vibration app, said assembly comprising:
a cushion being configured to have a user positioned thereagainst, said cushion having a pocket being integrated therein, said pocket insertably receiving a personal electronic device, said cushion being comprised of a resiliently compressible material thereby facilitating vibration from the personal electronic device to be communicated through said cushion wherein said cushion is configured to enhance comfort for the user by exposing the user to the vibration, said cushion having an outer surface, said outer surface having a first lateral side, a top side and a bottom side, said pocket being positioned between said top side and said bottom side, said pocket being positioned adjacent to said first lateral side, said pocket being oriented to extend along a horizontal plane wherein said pocket is configured to enhance the ease with which the user can insert said personal electronic device into said pocket, said first lateral side having a cut extending into said pocket thereby facilitating said personal electronic device to be inserted into said pocket.
